(19) United States
(12) Patent Application Publication
(10) Pub. No.: US 2004/0210473 A1
(43) Pub. Date: Oct. 21, 2004

(54) Method and system for forecasting resources for the development of pharmaceutical drugs

(75) Inventor: Daniel Goddard, West Hartford, CT (US)

Correspondence Address: PFIZER INC, 150 EAST 42ND STREET, 5TH FLOOR - STOP 49, NEW YORK, NY, 10017-5612, US

(73) Assignee: Pfizer Inc., New York, NY

(21) Appl. No.: 10/704,453

(22) Filed: Nov. 7, 2003

Related U.S. Application Data
(60) Provisional application No. 60/425,195, filed on Nov. 8, 2002.

(51) Int. Cl. G06F 17/60

(52) U.S. Cl. 705/10

(57) ABSTRACT

The method and system of the present invention is a Resource Forecasting Model (hereinafter “the RFM”). The RFM is a model of the Drug Development Process. More specifically, the RFM calculates Direct Project Resources for the development process of pharmaceutical drug Candidates, for a user-selected Forecast Period after initial discovery of the Candidates until final FDA regulatory approval thereof. The present invention provides a computer system with a database, a server, and a client. The client may be connected to the database and server via a direct connection, such as a local network, or via a web-based connection.

### BACKGROUND OF THE INVENTION

1. Field of the Invention

This invention relates to methods and systems for forecasting resources needed during product development. In particular, this invention relates to such methods and systems for forecasting resources needed during the development of pharmaceutical drugs.

2. Description of the Prior Art

The pharmaceutical Drug Development Process is complicated, time-consuming, and costly. The success of the pharmaceutical drug is uncertain in the development process. Developing a successful pharmaceutical drug has been likened to searching for the proverbial needle in a haystack. Literally hundreds, and sometimes thousands, of candidate pharmaceutical compounds must be made and variously tested to find one that can achieve the desired therapeutic result without unacceptable side effects. Moreover, the therapeutically successful drug must also be commercially producible and readily patient useable.

The complexity of the Drug Development Process can be gauged, in part, by the number of scientists and the diversity and sophistication of the scientific and technological disciplines engaged in finding new drugs. Traditional organic chemists, physiologists and statisticians have been joined in recent years by new kinds of specialists. Biochemists study the chemistry of life processes. Molecular biologists study the molecules that make up living matter. Toxicologists investigate chemicals' potential for harm. Pharmacologists look at how drugs work. Computer scientists apply the increasing power of sophisticated software and hardware to analyze and assess pharmaceutical drug candidates.

This complicated Drug Development Process requires an extraordinary investment of resources, namely personnel, capital, and time. The FDA estimates that, on average, it takes eight-and-a-half years to study and test a new drug before the agency can approve it for the general public. That includes early laboratory and animal testing, as well as later clinical trials using human subjects. The Tufts Center for Drug Development estimates that the process of developing a new drug takes on average 14.2 years from initial screening of the molecule to the time the product is launched into the market. According to a 1993 report by the Congressional Office of Technology Assessment, drug companies spend an average of $359 million to develop a new drug. The Tufts Center for Drug Development estimates that the cost of drug development is in excess of $800 million for each product that succeeds in finally reaching the marketplace.

One of the greatest challenges in conducting clinical trials is that of efficiency. As trials become more comprehensive, involving up to thousands of patients in many countries, they cost more and take longer to complete. The new industrial revolution in information technology offers opportunities for more economical use of resources needed for clinical trials.

The Drug Development Process is wholly unlike the development process for any other product. Typically, manufacturers do not have to generate several hundred thousand pages of supporting data and conduct numerous clinical trials in order to receive government permission to sell their products. Unlike typical product manufacturers, pharmaceutical companies must spend more in development and manage significantly more risk. This, in turn, creates a demand for more sophisticated and specialized forecasting techniques.

Prior art methods are generally unrelated to the pharmaceutical Drug Development Process.

A method for allocating resources to certain service industries is disclosed in U.S. Pat. No. 5,963,911 to Walker et al. A system for estimating costs, such as software development project costs, is disclosed in U.S. Pat. No. 6,073,107 to Minkiewicz et al. A resource allocation method using uncertainty factors for pricing determinations is disclosed in U.S. Pat. No. 6,219,649 to Jameson. A method for optimizing a business planning model is disclosed in U.S. Pat. No. 6,308,163 to Ouimet et al. A method for analyzing a business improvement program is disclosed in U.S. Pat. No. 6,321,205 to Eden.

The prior art forecasting methods are not directed to a product development resource forecasting model, particularly a resource forecasting model specifically directed to the pharmaceutical Drug Development Process. To date, there is disclosed no resource forecasting model that encompasses the myriad complex factors and uncertainties peculiar to the pharmaceutical Drug Development Process.

### SUMMARY OF THE INVENTION

It is therefore an object of the present invention to provide a resource forecasting model for forecasting resources needed for the development of pharmaceutical drugs.

It is also an object of the present invention to provide a resource forecasting model method and system.

The method and system of the present invention is a resource forecasting model for the pharmaceutical Drug Development Process. More specifically, the resource forecasting model calculates direct project resources for the development process of pharmaceutical drug candidates, for the period after initial discovery of the candidate until final FDA regulatory approval. The present invention provides a computer system with a database, a server, and a client. The client may be connected to the database and server via a direct connection, such as a local network, or via a web-based connection.

### BRIEF DESCRIPTION OF THE FIGURES

FIG. 1 shows the overall structure of a Resource Forecasting Model according to the present invention;

FIG. 2 shows the high level process view of the Resource Forecasting Model of FIG. 1;

FIG. 3 is a schematic representation of the Database of the Resource Forecasting Model of FIG. 1;

FIG. 4 is a schematic representation of the Product Data for a Candidate in the Database of FIG. 3;

FIG. 5 is a schematic representation of the Paradigm Data for a Candidate in the Database of FIG. 3;

FIG. 6 is a schematic representation of the Activity Data for a Candidate in the Database of FIG. 3;

FIG. 7 is a schematic representation of the Site Data for a Candidate in the Database of FIG. 3;

FIG. 8 is a timeline for the Drug Development Process illustrating activity timing and resource consumption for an illustrative Candidate in the Database of FIG. 3;

FIG. 9 shows a Resource Forecasting Model System according to the present invention; and

FIG. 10 is a basic algorithm for the Resource Forecasting Model of FIG. 1.

### DETAILED DESCRIPTION OF THE INVENTION

1. Definitions

The following terms and phrases as herein before and herein after used, are defined for the present invention.

“Drug Development Process”—activities beginning after initial discovery of a prospective pharmaceutical drug candidate (“the Candidate”) and continuing until final approval of the new drug by the Food and Drug Administration (FDA). The Drug Development Process includes at least four phases. Phase I includes clinical trials in which researchers test the drug on small groups of people (5-80) for safety, adverse reactions, and proper dosage. Phase I lasts about 1 year. Phase II clinical trials are similar to Phase I trials, except the drug is given to a larger group of participants (100-300), and the main focus is efficacy. Initial studies in Phase II have a short term (e.g., about 2 weeks) and are called “early Phase II” or Phase IIA studies. Subsequent studies have a longer term (e.g., about 3 months) and are called “late Phase II,” R2D2, or Phase IIB studies. Phase II lasts about 1.5 years. Phase III trials typically include between 1,000 and 3,000 participants who are monitored for their reaction to the drug and the drug's effectiveness when compared to existing treatments. Phase III lasts about 3 years. Registration is the fourth phase, in which a New Drug Application is prepared and filed with the FDA for approval. Registration can last up to about 4 years. Additional phases may occur during the Drug Development Process.

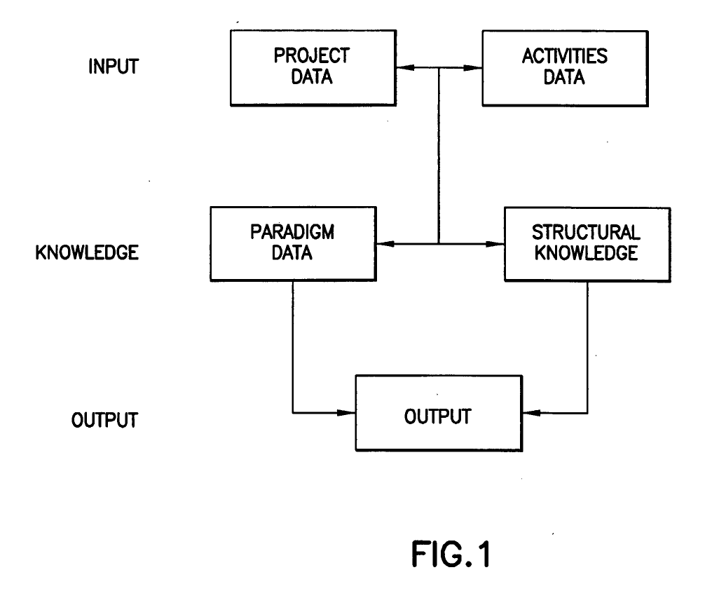

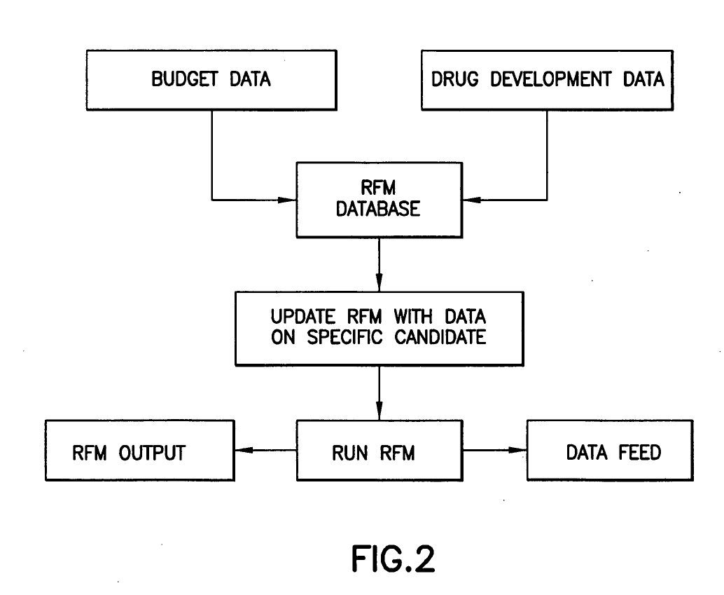

“Resource Forecasting Model” or RFM is a model of the Drug Development Process. The RFM forecasts Direct Project Resources for the Drug Development Process. The RFM forecast is for a Forecast Period. See FIGS. 1 and 2.

“Forecast Period” is a user-selected period of time for which a forecast of Direct Project Resources is desired. The Forecast Period may be equal to or less than the period of time for the Drug Development Process.

“Direct Project Resources” include, for example, Full Time Equivalents, and direct dollar expenditures for items such as animals and feed, lab chemicals, lab services, manufacturing services, comparative agents, and/or costs of Clinical Trials.

“Full Time Equivalent” or FTE is a person-year of work by employees or contractors. One (1) person working full time for one (1) year is one (1) FTE. Four (4) people working full time on a task for three (3) months is also one (1) FTE. Two (2) people working 50% of their time on a task for one (1) year is likewise also one (1) FTE.

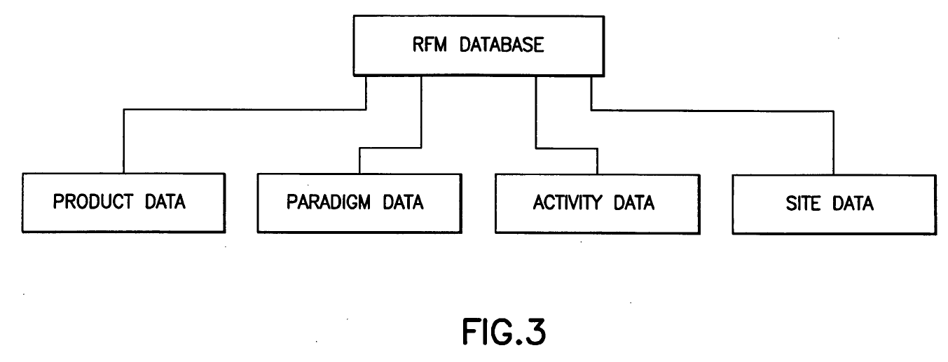

“Input Data” includes Product Data, Paradigm Data, Activity Data, and/or Site Data, as these specific terms are hereinafter defined. See FIG. 3.

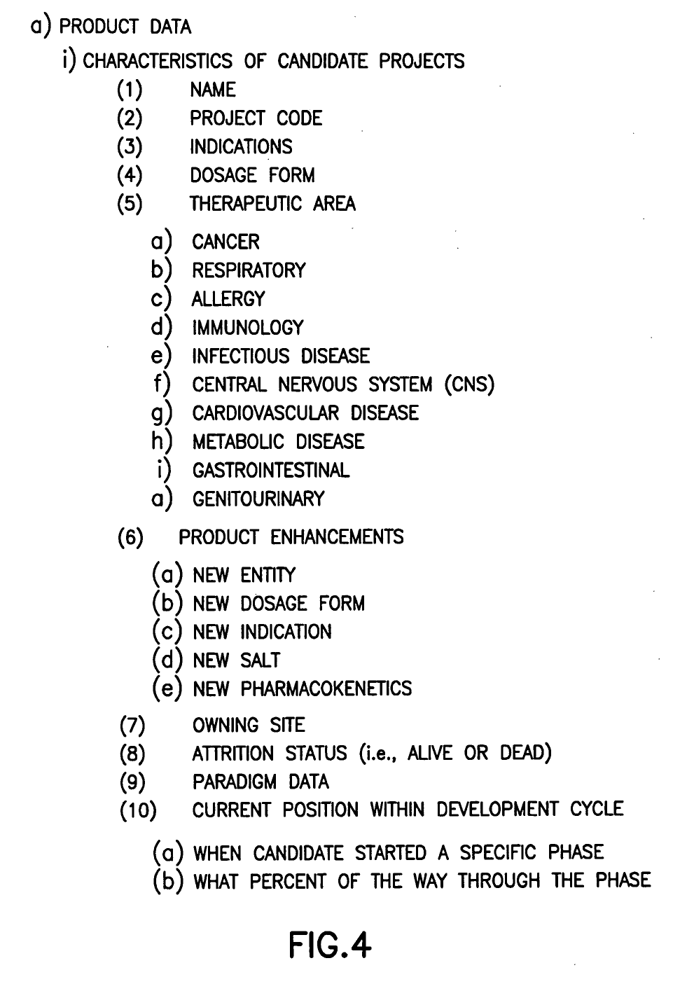

“Product Data” means Characteristics of a Candidate, and optional over-rides of various calculation factors, details about major Clinical Trials, and over-rides of the final results. See FIG. 4.

“Candidate” means a pharmaceutical drug in the Drug Development Process.

“Characteristics of the Candidate” may include the name and/or project code, indications, dosage form, product type, Therapeutic Area, Enhancement Status, current position in Drug Development Process, owning Site, Paradigm Data, and/or Attrition status (i.e., active or dead).

An “Active Candidate” is a Candidate that has not been “killed” and is between initial Candidate status and final regulatory approval by the FDA.

“Therapeutic Area” includes cancer, respiratory, allergy, immunology, infectious disease, central nervous system, cardiovascular, metabolic disease, gastrointestinal, and/or genitourinary.

“Enhancement Status” means new entity, new dosage form, new indication, new salt, or new pharmacokinetics.

“Paradigm Data” are based on Characteristics of the Candidate and includes phases of the Drug Development Process for the Candidate, timing of those phases, Activities in the phases, timing of the Activities in the phases, Attrition Adjustment Factors in the phases, the number and type of protocols, and the number of patients for the protocols. See FIG. 5.

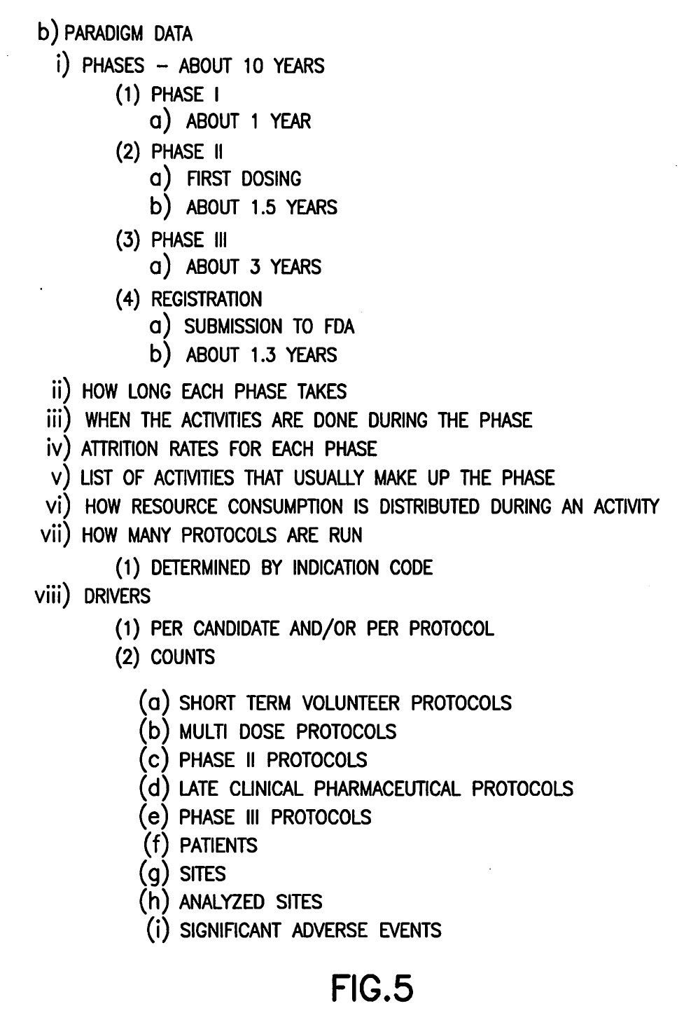

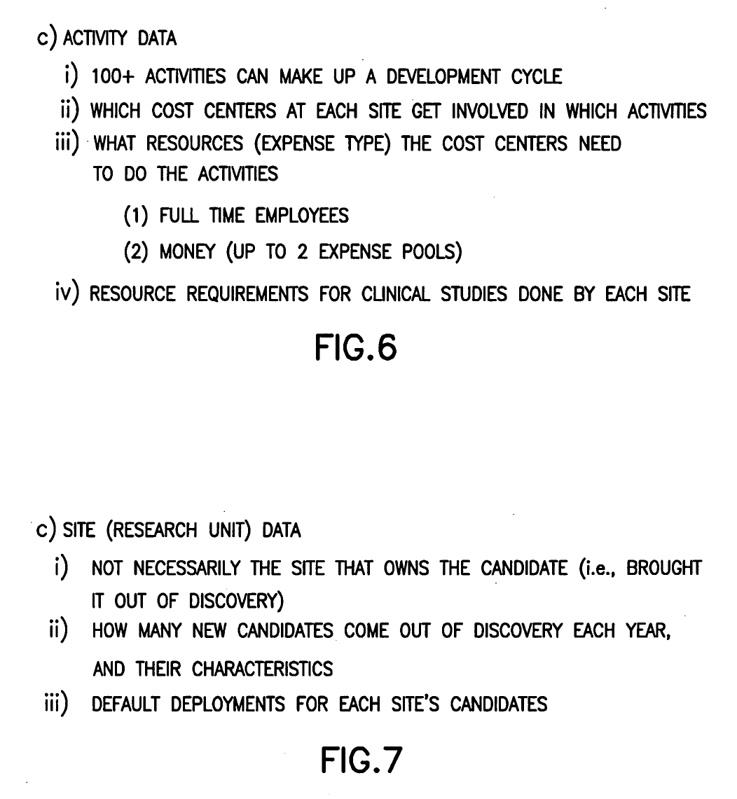

“Activities” are the events at the Cost Center level that can occur during the phases of the Drug Development Process. Activities include, but are not limited to, dosing, managing clinical trials, developing the manufacturing process, etc. Information or data relative to Activities include, specific timing of the Activities, Cost Centers at each Site that perform the Activities, and specific Resource Consumption of the Cost Centers. See FIG. 6.

“Site” is the location where an Activity is done, which may not be the Site that owns the Candidate. The owning Site is generally the site that brought the Candidate into the Drug Development Process. Each Site has numerous Cost Centers.

“Site Data” is data for the research unit including the number and characteristics of the new Candidates that enter the Drug Development Process at the Site, Default Deployments for the Candidates being developed by the Site, and information on how the site manages Clinical Trials, such as how many research sites are expected and costs per patient. See FIG. 7.

“Cost Center” is a group at a Site that performs Activities.

“Cost Drivers” cause the expenditure of Direct Project Resources. For the RFM, a Cost Driver may be an individual Candidate, an Activity, or any other cause or factor that is appropriate for the RFM, such as the number of protocols or patients at a Site.

“Deployment” refers to the percentage of work for each Activity that a Site is actually doing. “Default Deployment” assigns 100% of the work to the Site that owns the Candidate.

“Protocols” or “Clinical Trials” are studies performed using human patients wherein the patients are exposed to or dosed with the Candidate and the effects of the exposure or dosing are observed and compared to another drug or placebo.

“Adjustment Factor” will change the forecasted consumption of Direct Project Resources. Adjustment Factors can be used to adjust consumption up or down, or to turn off a Site/Cost Center/Activity combination entirely by setting an Adjustment Factor to zero. A given Adjustment Factor may be Candidate-specific or Overall.

“Overall Adjustment Factors” cannot be overridden for an individual product. Overall Adjustment Factors are applicable to all Candidates.

“Attrition” is when a Candidate is removed from the Drug Development Process. “Survival” is the opposite of Attrition.

“Attrition Adjustment Factor” for a given Active Candidate is the probability of Attrition within the Forecast Period. The Attrition Adjustment Factor may be applied to the forecast once at the end of the Forecast Period, if Attrition is assumed to occur only at the end of the Forecast Period. Alternatively, the Attrition Adjustment Factor may be applied to the forecast as a function of time or some other factor, if Attrition is assumed to occur at some rate during the Forecast Period. Such a function may be linear, exponential, or any suitable shape and magnitude. In addition, another Adjustment Factor may be applied to the Attrition Adjustment Factor to take into account some Characteristic of the Candidate, such as the amount of time that the Candidate is expected to take to complete a Phase within the Forecast Period.

“Serious Adverse Event” (SAE) is any event resulting in: a death, a life threatening experience, an in-patient hospitalization or prolongation of existing hospitalization, an emergency department visit, a discontinuation from a study for medical reasons, a persistent or significant disability/incapacity, development of a cancer or a congenital anomaly or birth defect.

“Database” is the collection of Input Data for the RFM. The collection includes Input Data relative to both historical and active Candidates. Preferably, the database is a relational database, such as an Oracle® Database.

2. Description of the Method

The method of the present invention is a resource forecasting model (hereinafter “the RFM”). The RFM is a model of the Drug Development Process. More specifically, the RFM calculates Direct Project Resources for the Drug Development Process of a Candidate. The RFM outputs are based on the Candidate-specific phases of the development process rather than pre-set milestones. The RFM may be utilized to provide resource planning (e.g., budgets), resource forecasts for tax planning or contract negotiations, and also provide strategic planning, such as risk analysis, scenario analysis, and hypothesis testing.

One embodiment of the present invention is a method for forecasting consumption of Direct Project Resources for a Candidate pharmaceutical drug during a user-selected Forecast Period in a Drug Development Process. The method comprises the steps of: providing Characteristics of the Candidate; selecting the Forecast Period; selecting a Site, the Site having a Cost Center that performs at least a portion of an Activity for the Candidate, the Activity requiring Direct Project Resources; and forecasting consumption of the Direct Project Resources at the Cost Center in the Forecast Period by determining the Direct Project Resources, adjusted by the portion of the Activity completed in the Forecast Period, the portion of the Activity deployed to the Cost Center, and an Attrition Adjustment Factor for the Candidate.

Another embodiment of the present invention, otherwise broadly stated, is a method of forecasting required Direct Project Resources for a Drug Development Process. The method comprises the steps of: providing information for a Candidate pharmaceutical drug relative to Characteristics of the Candidate in a Drug Development Process; providing information relative to Activities that are performed during the Drug Development Process; selecting a Forecast Period; determining for the Candidate an expected position in the Drug Development Process and an Attrition Adjustment Factor; determining Activities in the Forecast Period that are at least partially completed; and determining Direct Project Resources for the Activities in the Forecast Period, wherein the Direct Project Resources are modified by the Characteristics of the Candidate and the Attrition Adjustment Factor to provide a forecast of the Direct Project Resources required for the Candidate during the Forecast Period.

A further embodiment of the present invention is a system for forecasting required Direct Project Resources for a Drug Development Process. The system comprises: database means for storing information for a Candidate pharmaceutical drug relative to Characteristics of the Candidate in a Drug Development Process; database means for storing information relative to Activities that are performed during the Drug Development Process; and computer means for calculating a forecast of Direct Project Resources required for the Candidate during a user-selected Forecast Period. The computer means calculates the following for the Candidate: (i) an expected position in the Drug Development Process, (ii) an Attrition Adjustment Factor, (ii) Activities in a user-selected Forecast Period that are at least partially completed, and (iii) Direct Project Resources required for the Activities in the Forecast Period modified by the Characteristics of the Candidate and the Attrition Adjustment Factor.

Referring to FIG. 1, the overall structure of the RFM Database is charted. The inputs are Project Data and Activities Data. The knowledge level includes the Paradigm Data and the structure knowledge (i.e., business logic and calculations).

The high-level process view of the RFM is charted in FIG. 2. The RFM Database includes financial and drug development data. Consumption and deployment data update the RFM Database. The RFM is run and provides output for user review. Output data from the RFM may be adapted for input into many types of software.

a. The Database

Referring to FIG. 3, the method of the present invention utilizes a Database of information for describing the current Candidates and the Drug Development Process. The data in the Database are divided into four major categories: Product Data, Paradigm Data, Activity Data, and Site Data. Product data includes: the Characteristics of the Candidate, overrides of various calculation factors, details about major clinical trials, and overrides of the final results. Paradigm Data includes: applicable Phases, duration of the Phases, rates of Attrition within each Phase, the Activities in each Phase, the timing and duration of the Activities, and the timing and duration of any applicable Protocols. Activity Data includes: the Activities that are done by each Cost Center at each Site, what resources are used by the Cost Centers to perform each Activity, and resource requirements for clinical studies done by each Site. Site data includes how many Candidates come out of discovery each year, the Characteristics of the Candidates, and Default Deployments for each Site's new Candidates.

New Active Candidates may be included in the Database in at least one of two ways. First, exact Characteristics and timing, as further described below, for a new Active Candidate can be specified by creating a specific entry or “placeholder” in the Database. Placeholders may also be made for new Active Candidates that enter the Drug Development Process at a later point. Alternatively, generic new Active Candidates can be automatically generated and evenly spread throughout a specified time period. For example, if four new Active Candidates begin the Drug Development Process in a given year, one generic new Active Candidate will automatically be generated for, e.g., February, May, August, and November.

As shown in FIG. 4, an Active Candidate has various Characteristics that are recorded in the Database. These Characteristics include: name and/or project code, indications, dosage form, product type, Therapeutic Area, Enhancement Status, current position in the Drug Development Process, owning Site, Paradigm Data, and Attrition status (i.e., alive or dead). The current position in the Drug Development Process for each Candidate is usually expressed as when it started and/or ended a specific Phase; it can also be what percent of the way through a Phase it was as of a certain date. The specific duration for each Phase for a given Candidate depends on the Product and Paradigm Data. For example, a speed override factor can be set for a given Candidate, to force it to move faster or slower than average.

The Database contains every possible Phase in the Drug Development Process, and the Activities that take place during those phases. Paradigm Data for a particular Candidate defines the Phase durations, Activities, Activity durations, required resources, and Attrition rates. The specific Phases, Phase durations, Activities, Activity durations, required resources, and Attrition rates are determined by reference to the Product Data and user overrides.

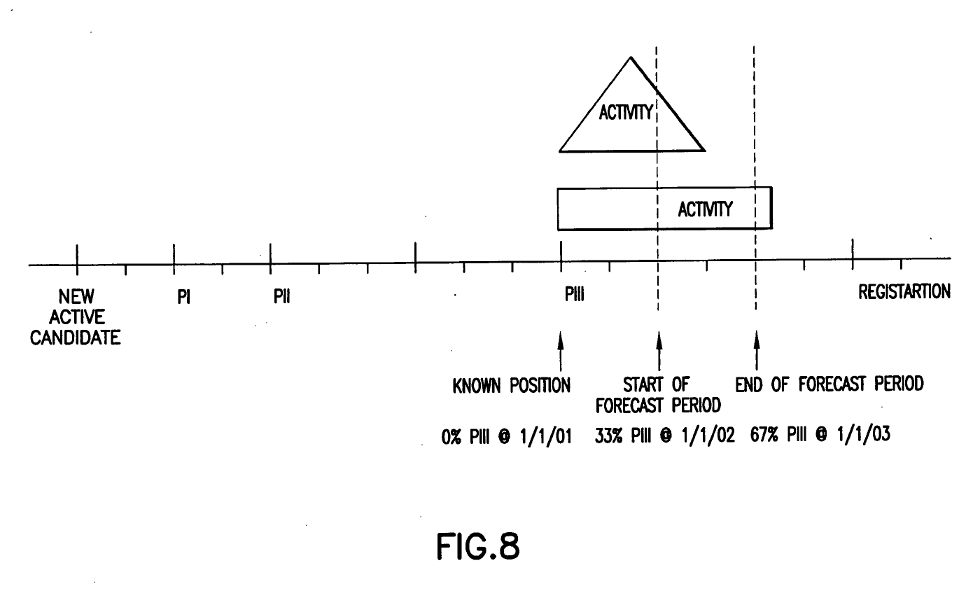

Referring to FIG. 5, there are well over 100 Activities that can make up the Drug Development Process for a Candidate. The Paradigm Data includes when each Activity occurs during the Drug Development Process. For each Activity in the RFM, a user may specify exactly when an Activity occurs during the development cycle. For example, an activity might go from 0% of Phase III to 75% of Phase III (see FIG. 8).

Referring to FIG. 6, the Activity Data includes which Cost Centers at each Site are involved in the Activity, and how many resources the Site needs for the Activity. Each Site specifies what resources each Cost Center needs for each Activity.

Referring to FIG. 8, users also have the ability to specify how resource consumption is distributed over an Activity. Preferably, resource consumption may be specified as uniform or triangular. When resource consumption is uniform, resources are consumed at a constant rate. When resource consumption is triangular, resources are consumed at a variable rate that starts at 0%, rises linearly to a maximum rate, and then decreases to 0%. In general, regardless of how fast the active Candidate is moving through a given activity, consumed resources are assumed to be a certain fixed amount.

The RFM recognizes two major expense types: (1) the number of Full Time Equivalents needed, and (2) direct dollars expenditures. The RFM organizes monetary expenses into expense pools. Preferably, the RFM calculates Full Time Employees and two other expense pools per Cost Center. In general, the Site determines which expense pools are calculated for each Cost Center.

Deployment in the RFM refers to which site is actually doing the work on a product. Work for a product may be done at sites other than the owning site. The RFM's default user-adjustable assumption is that the owning site will do all the work.

Many Direct Project Resources are only required once for each individual Candidate and can easily be specified by using each individual Candidate. On the other hand, it may be easier and more accurate to specify Direct Project Resources by protocol, patient, SAE, Site, or some other Cost Driver. For example, Direct Project Resources required for an SAE may be specified by each SAE, instead of by each Candidate. Preferably, the RFM calculates Cost Drivers by Site. When a Cost Driver is specified, any data related to Deployment is preferably superseded or replaced by the data related to the specified Cost Driver.

A Complexity Factor may be assigned to a particular Candidate. The Complexity Factor is an Adjustment Factor that adjusts resource consumption for a particular Candidate.

For each Site/Cost Center/Activity combination, there are also Adjustment Factors that cannot be overridden for an individual Candidate. These Overall Adjustment Factors can be used to adjust consumption up or down, or, by setting a factor to zero, to turn off a Site/Cost Center/Activity combination entirely. One Overall Adjustment Factor is based on Product Enhancement Status. This works the same way for all Cost Centers. Normally a new Active Candidate (an “NCE”, or New Chemical Entity) gets a factor of 1.0, and the different types of Enhancements (e.g., new salt, new dosage form, etc.) get factors below (and occasionally above) the new Active Candidate. The consumption for the Site/Cost Center/Activity, both FTE's and dollars, is multiplied by the factor for the Enhancement Status. Another Overall Adjustment Factor is Product Type. Usually, an immediate-release tablet gets a factor of 1.0 and other Product Types (e.g., controlled-release tablet, liquid, etc.) get a factor above or below 1.0. A third Overall Adjustment Factor is by Therapeutic Area.

b. Calculations

For a Forecast Period, the RFM forecasts where a given Candidate will be in the Drug Development Process during the Forecast Period. Based on the forecast of where a given Candidate will be in the Drug Development Process, the RFM also forecasts what resources the given Candidate will need during the Forecast Period.

The following description is directed to calculations for a single Candidate and a single Forecast Period. However, the RFM may also forecast resources required for a portfolio comprising many Candidates, such as when the forecast is for a Site or Cost Center. In addition, the RFM may forecast resources required for multiple Forecast Periods. In other words, the RFM may provide a single forecast for a Forecast Period of 10 years, or 10 forecasts for 10 Forecast Periods of 1 year each.

The RFM uses the current position of the Candidate in the Drug Development Process. The current position is expressed by the start and end dates of a specific Phase or as a percentage of the way through the Phase it is at on a specific data. Positions of the Candidate in the RFM are preferably expressed as a percent of the way through a Phase, rather than as a percent of the whole Drug Development Process or absolute time, because of the variance in Phase length from one Candidate to another and from one Phase to another.

For example, referring to FIG. 4, the Candidate began Phase III on Jan. 1, 2001. From the Paradigm Data for this Candidate, Phase III is expected to take 3 years. Thus, the Candidate will go from 33% to 67% of Phase III during the year 2002.

The RFM can extrapolate forward over multiple Phases until the Candidate either dies or gets to market. If the user-specified position of the Candidate is in the future, the RFM can extrapolate backwards to calculate the current position of the Candidate. The duration for each phase depends on the Paradigm Data the Candidate is following, as modified by other Product Data and user-overrides. For example, users are able to set an Adjustment Factor for speed that calculates the Candidate to move faster or slower than average.

The RFM is used for both short-term and long-term forecasting of the resources needed to develop a Candidate. The RFM provides point estimates (“expected values”), as well as distributions of possible outcomes based on one or more simulations.

The basic algorithm for the RFM is shown in FIG. 10.

The calculation is done for each Forecast Period for each Active Candidate for each Site for each Cost Center for each Activity for each Expense Type. Consumption equals Activity Resources, modified by the extent the Activity is complete (in percent), Deployment (in percent), Cost Drivers, Candidate-specific Adjustment Factors, Overall Adjustment Factors, and an Attrition Adjustment.

Other basic formulas used in the RFM are:

Patients=number of Protocols×Patients per Protocol

Sites=Patients÷Patients per Site

Trials $=Patients×$ per Patient

Clinical Research Associates (CRAs)=Sites÷Sites per CRA

CRA FTE's=CRA's×Protocol Duration

Clinicians=# of Protocols÷Protocols per Clinician

Clinician FTE's=Clinicians×Protocol Duration

Administrators=# of Protocols÷Protocols per Administrator

Administrator FTE's=Administrators×Protocol Duration

Analyzed Sites=Sites×% of Sites Analyzed

SAE's=Patients÷Patients per SAE

The defaults for number of protocols and patients per protocol are determined by the Paradigm Data (i.e., the Indication Code). Preferably, both defaults can be overridden for an individual Candidate by Site.

The defaults for patients per Site, dollars per patient, Sites per CRA, protocols per clinician, protocols per administrator, and protocol duration are determined by Site by Indication Code. Preferably, patients per Site, dollars per patient, and protocol duration can be overridden for an individual Candidate by Site.

The Forecast Period may be any period of time for which the user wants a forecast. The Forecast Period may be the calendar year or the tax year. Preferably, the RFM allows a user to specify both the start date and duration of the Forecast Period. In addition, sets of fixed start dates and durations may be provided to the user for ease of use.

The Attrition Adjustment Factor is the probability that the product will still be alive during the Forecast Period. Attrition may be assumed to occur (1) at the end of the Phase only; (2) at some rate during a Phase as a function of time, with a predetermined shape and magnitude; or (3) as a combination of the two. For example consider a given Active Candidate that is 17% into Phase III on Jul. 1, 2001 and the expected duration of Phase III is three years. The given Active Candidate will progress from 33% of Phase III at the beginning of the Forecast Period (Jan. 1, 2002) to 67% of Phase III at the end of the Forecast Period (Jan. 1, 2003). If Attrition is 70% during Phase III and occurs linearly over time, then 95% of all Active Candidates will be alive at 17% of Phase III, 90% of all Active Candidates will be alive at 33% of Phase III, and 80% of all Active Candidates will be alive at 66% of Phase III. Since the Attrition Adjustment Factor is a function of position of the given Active Candidate in the Phase, and the given Active Candidate is alive at 17% of Phase III on Jul. 1, 2001, the probability that the given Active Candidate will be alive on Jan. 1, 2002 is 94.7% and the probability that the given Active Candidate will be alive on Jan. 1, 2003 is 84.2%. For the sake of programming convenience, the RFM may average these two survival probabilities to arrive at an Attrition Adjustment Factor of 89.45%. Alternatively, if we assume Attrition only happens at the end of a Phase, the Attrition Adjustment Factor for a given Active Candidate is 100% when the given Active Candidate has not survived the Phase. If appropriate, the Attrition Adjustment Factor may be adjusted based on how fast or slow a Candidate moves between two positions in the Phase.

Each Active Candidate will have an Attrition Adjustment Factor. An Attrition Adjustment Factor can be assigned to each Active Candidate using any suitable method. For example, every Active Candidate in a given Therapeutic Area may be assigned the same Attrition Adjustment Factor. A more preferred method of assigning an Attrition Adjustment Factor to an Active Candidate is based on confidence ratings developed from historical data. For example, an Active Candidate may be assessed with a safety rating (“Confidence in Safety”) and a functional rating (“Confidence in Rationale”) based on data from similar or related historical candidates. An Active Candidate with a high Confidence in Safety is more likely to be non-toxic in comparison to an Active Candidate with a low Confidence in Safety. Thus, the Active Candidate with a high Confidence in Safety is more likely to be alive at the end of a forecasting period in comparison to the Active Candidate with a low Confidence in Safety. Similarly, an Active Candidate with a high Confidence in Rationale is more likely to be therapeutically effective in comparison to an Active Candidate with a low Confidence in Rationale. Thus, the Active Candidate with a high Confidence in Rational is more likely to be alive at the end of a forecasting period in comparison to the Active Candidate with a low Confidence in Rationale. Furthermore, the two confidence ratings may be used in conjunction to define a grid with four or more sectors, wherein Active Candidates in a given sector have the same Attrition Adjustment Factor. Active Candidates in sector 1 having both a low Confidence in Safety and a low Confidence in Rationale will be assigned an appropriately high Attrition Adjustment Factor because it is relatively likely that Active Candidates in sector 1 will not survive to the end of the given Forecasting Period. Active Candidates in sector 4, having both a high Confidence in Safety and a high Confidence in Rationale, will be assigned an appropriately low Attrition Adjustment Factor because it is relatively like that Active Candidates in sector 4 will survive to the end of a given forecasting period. Active Candidates in the remaining sectors will have either a high Confidence in Safety, but low Confidence in Rationale (sector 2), or a low Confidence in Safety, but high Confidence in Rationale (sector 3). The respective Attrition Adjustment Factors for sectors 2 and 3 will be higher than sector 4 and lower than sector 1. The respective Attrition Adjustment Factors for sectors 2 and 3 may be the same or different depending on factors, such as the comparative importance between the confidence ratings. For example, if Confidence in Safety is more important than Confidence in Rationale, then Active Candidates in sector 2 will have a lower Attrition Adjustment Factor than those Active Candidates in sector 3 because safer, less therapeutic Active Candidates are more likely to survive a forecasting period compared to more therapeutic, less safe Active Candidates. An advantage provided by using Attrition Adjustment Factors is the ability to gradually increase successful candidates over time by removing low probability candidates from the development process earlier.

Preferably, Active Candidates will be modeled according to the date they started the development process because the goal of the system and method of the present invention is to accurately model business practices and goals specifically applicable to individual Active Candidates. For example, if 25% of the Active Candidates in development before a certain date are expected to survive to final approval, but only 20% are expected to survive to final approval after that certain date, then the system and method of the present invention must reflect that change in attrition. However, if such a change in the model is to be accurate across all Active Candidates, all Active Candidates must be modeled in light of the date they entered the development process. In other words, a particular Active Candidate that entered the development process prior to the model change, must be assessed by the old model (i.e., 25% survival) rather than the new model (i.e., 20% survival).

c. Expected Value Estimation

The method of the present invention provides point estimates from averages based on selected input data from the RFM Database. The point estimates are used for budget and short term forecasting (i.e., less than 2 years).

For example, if $8,000 is spent per patient in a particular phase, 20 patients would have an expected value of $160,000. By varying the number of patients and the amount spent per patient, a different expected value is generated. A user generally must use past experience to determine whether a given point estimate is accurate.

d. Simulation

The method according of the present invention may provide output data from one or more simulations based on selected input data from the RFM Database. Output data from simulations is used for long term analysis (i.e., more than 2 years) and to evaluate variances in the expected valves generated by the present method, as described above. Simulations provide a distribution of possible outcomes. The output data is defined by mean, standard deviation, variance, skewness, percentiles, and confidence levels.

The simulation technique used by the present method is preferably a “Monte Carlo” simulation. A Monte Carlo simulation randomly generates values for uncertain variables in a given model. For each uncertain variable, the possible values are defined by a probability distribution. Probability distribution types include: normal, triangular, uniform, gamma, and binomial. The simulation engine runs numerous iterations in which the randomly generated values are used in the forecasting model. After a large number of iterations, a probability for each possible value is provided. Thus, using a Monte Carlo simulation, the forecasting model does not provide a single value for each uncertain variable. Instead, the forecasting model uses a Monte Carlo simulation to provide a range of values and their respective probabilities. Besides Monte Carlo simulations, other simulation techniques may be used by the method of the present invention, including historical simulations.

The output data is preferably provided as an output file in a format appropriate for a spreadsheet program, such as Microsoft® Excel®. The advantage of using a spreadsheet program is that the summarization and format of the output file may be changed to more effectively display the output data. For example, the output data can be formatted as a graph, as well as a standard table.

Factors that affect the outcome of a simulation include: the number of protocols, the number of patients per protocol, the amount of money spent on each patient, the start and end dates of a protocol, enrollment rates, payment delays.

The following describes exemplary distributions for certain input values. Parameters (average, standard deviation, etc.) are specified in the RFM Input Data.

Phase Durations

Average of two Gamma variables with the same average and standard deviation.

One is capped above by the maximum; one is capped below by the minimum.

Attrition (or Survival)

Binomial variable, for 1 trial, with the probability equal to the survival rate for the time period involved.

Adjustment Factors (e.g., Complexity)

Gamma variable.

Number of Protocols

Discrete variable; the set of possible outcomes and the probability of each is defined in the RFM input.

Number of Serious Adverse Events (SAE's)

Normal variable, used as an approximation to the sum of a Poisson variable for each patient.

New Candidate TAG

Discrete variable; the probability of each TAG for a given site is defined in the RFM input.

Several values use a special calculation referred to in the RFM as a Truncated Gamma. This calculation adapts to the amount of detail the user is able to specify about the distribution. Up to four inputs can be given: Average, Standard Deviation, Maximum, and Minimum. If the Minimum is not given, it is assumed to be zero.

If the Average and Standard Deviation are given, then a Gamma variable is used, capped by the Maximum and Minimum if they are given. Otherwise, if the Average and Maximum are given, two Triangle variables are used, one below the Average, one above, both peaking at the Average, and weighted so that the overall mean is the Average. Otherwise, if only the Maximum is given, a Uniform variable is used over the range (Minimum, Maximum). Otherwise, the Average is used as a fixed value.

This Truncated Gamma is used for Patients per Protocol, Dollars per Patient, Protocols per Clinician, Patients per Site, and Protocols per Clinician.

3. Description of the System

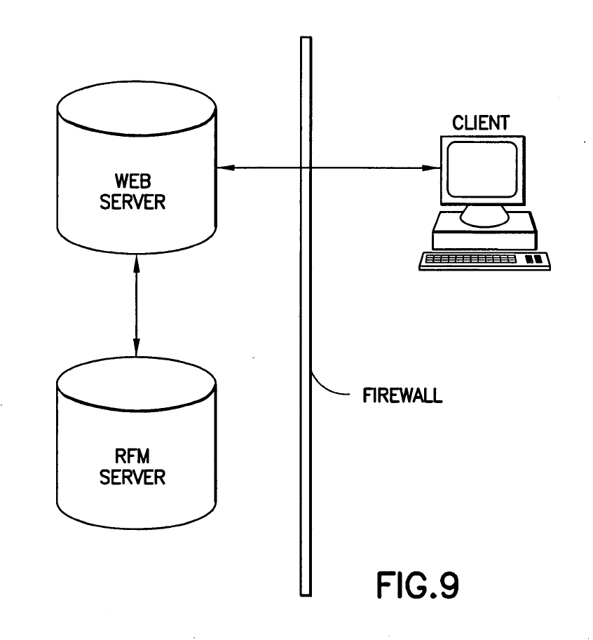

Referring in general to FIG. 9, the system according to the present invention uses a relational database, such as an Oracle Database, for the back end. ASP, VB Script, and Java Script technologies are preferably used for the front end. A dedicated application performs expected value and simulation modeling. Specifically, the system preferably uses Com+ and @Risk RDK.

The data is stored in an Oracle database. A user will preferably access the information remotely using a web browser on the client machine connected via a web server to and from the Oracle database. The user may access the data or update the data. The client side preferably has validation in a Java Script.

The core engine uses a COM object (ActiveX dII), a VB COM object, a COM+ application that encapsulates the VB corn object. The Web Server is a Windows 2000 server, IIS 5.0 (Internet Information Server). The system uses multi-threading/apartment threading to service multiple users simultaneously.

The user uses the command “Run Model” to get the information from the database. When the information is sent to the user, the information is sent out to an Excel 2000 spreadsheet. The users can view the information in any manner allowed by Excel 2000 or by buttons that are added by this program including “summarize by”.

The user receives an “expected value” with information about Cost Centers and Candidates, or may run a simulation to take the expected value and forecast. The user has buttons for “Add Simulation Output”, “Save to Web” to send to webserver folders “Reform Sim Output”. The expected values are sent to “Reform Output” as a link.

For simulations, the present invention uses @Risk RDK to generate random values and compile results. These jobs can be lengthy so an e-mail notifies the requestor when the simulation is complete.

In light of the foregoing, a preferably system according to the present invention includes Excel 2000, RDK 4.0 (Server Edition), IIS 5.0, MDAC 2.5 (for connecting to Oracle), CDONTS dII (for e-mail), Web Active Server Pages (ASP), and COM+.

Chart 1—Development Technologies

| Application | Tool, System, Database, Platform, Etc. | Comments |
|---|---|---|
| Application | Microsoft Visual Studio | |
| Development | | |
| Browser | Internet Explorer | |
| Business Rules | Visual Basic | COM object |
| Client Server | N/A | N/A |
| Architecture | | |
| Database | Oracle | |
| Database | ADO | OLEDB |
| Access | | |
| Database OS | Unix | |
| Platform | | |
| Security | Session based | |
| Software | Visual Source Safe | |
| Version Control | | |

4. Simulation Illustrative Example

The output from an expected value run of the RFM is opened within a spreadsheet program, such as Microsoft® Excel®. The user selects or creates a summary of the expected value output. Then, the user selects specific data (i.e., rows and columns) in the summary that display the values for which simulation results are desired. This user-selected data may also be referred by those skilled in the art as the “output range,” which is outputted from the cost center summary into the simulation. Once selected, the user-selected data will preferably be displayed as a new spreadsheet, which the user may review for correctness. The revised spreadsheet containing the user-selected data is then saved as a file that will be available to the RFM. Since the present system is preferably web-based, the new spreadsheet is saved to a web server. Once the user-selected data has been saved as a file on the web server, the file is closed.

From the web site for the RFM system, the user initiates a simulation session. A simulation session may be initiated by clicking a link (e.g., a “Run Model” button) or from a pull-down menu. The first action in a simulation session is providing the simulation model with the name of the file containing the user-selected data and the parameters for the period to be simulated. Then the simulation model may be run by clicking a link or pressing the enter key.

The simulation session may take several minutes to complete. Preferably, a confirmation screen is displayed to the user with an estimate of the run time for the simulation session. Run time will be impacted by the number of periods selected for the simulation, the number of simulation iterations, and the volume of traffic on the server.

When the simulation is completed, the user will receive confirmation. Confirmation may be received via any appropriate means, such as on the web site and/or via e-mail. The simulation engine produces an output file, which should be saved to a local drive to allow for future reference.

The method and system of the present invention provides output data of direct project-related demand for human resources (i.e., full time employees) and financial resources (i.e., money).

The RFM provides a resource forecasting model that is particularly designed and useful for forecasting resources needs in pharmaceutical drug development programs during all phases of such development programs.

It is understood that the above discussion, drawings and specific examples are illustrative of the present invention and that changes may be made in structure, components, relative relationships, method steps and the like without departing from the scope of the present invention as defined in the following claims.

What is claimed is:

1. A method for forecasting the consumption of Direct Project Resources for a pharmaceutical drug Candidate during a Forecast Period in a Drug Development Process comprising the steps of:
providing Characteristics of the Candidate;
selecting the Forecast Period;
selecting a Site, the Site having a Cost Center that performs at least a portion of an Activity for the Candidate, the Activity requiring Direct Project Resources;
forecasting consumption of the Direct Project Resources at the Cost Center in the Forecast Period by determining the Direct Project Resources adjusted by the portion of the Activity completed in the Forecast Period, the portion of the Activity deployed to the Cost Center, and an Attrition Adjustment Factor for the Candidate.

2. The method of claim 1, wherein the Direct Project Resources are further adjusted by Candidate-specific Adjustment Factors.

3. The method of claim 1, wherein the Direct Project Resources are further adjusted by Overall Adjustment Factors.

4. A method of forecasting Direct Project Resources required for a Drug Development Process comprising the steps of:
providing information for a pharmaceutical drug Candidate relative to Characteristics of the Candidate in a Drug Development Process;
providing information relative to Activities that are performed during the Drug Development Process;
selecting a Forecast Period;
determining, for the Candidate, an expected position in the Drug Development Process and an Attrition Adjustment Factor;
determining Activities in the Forecast Period that are at least partially completed; and
determining Direct Project Resources for the Activities in the Forecast Period,
wherein the Direct Project Resources are modified by the Characteristics of the Candidate and the Attrition Adjustment Factor to provide a forecast of the Direct Project Resources required for the Candidate during the Forecast Period.

5. The method of claim 4, wherein the information relative to Activities includes: when the Activities occur, Direct Project Resources that are needed for the Activities, and how the Direct Project Resources are modified by the Characteristics of the Candidate.

6. The method of claim 4, wherein the Characteristics of the Candidate are selected from the group consisting of: name, project code, indication, dosage form, product type, Therapeutic Area, Enhancement Status, current position in Drug Development Process, owning Site, Paradigm Data, Attrition status, and combinations thereof.

7. The method of claim 4, wherein the Direct Project Resources are calculated for each Forecast Period, for each Active Candidate, for each Site, for each Cost Center, for each Activity, and for each expense type.

8. The method of claim 4, wherein the Direct Project Resources are selected from the group consisting of: personnel, materials, time, and combinations thereof.

9. The method of claim 4, wherein the Direct Project Resources are determined by an expected value estimation.

10. The method of claim 4, wherein the Direct Project Resources are determined by a simulation.

11. The method of claim 10, wherein the simulation is a Monte Carlo simulation.

12. The method of claim 4, wherein the Direct Project Resources are further adjusted by a Cost Driver.

13. The method of claim 4, wherein the Direct Project Resources are further adjusted by a Candidate-specific Adjustment Factor.

14. The method of claim 4, wherein the Direct Project Resources are further adjusted by an Overall Adjustment Factor.

15. A system for forecasting required Direct Project Resources for a Drug Development Process comprising:
database means for storing information for a pharmaceutical drug Candidate relative to Characteristics of the Candidate in a Drug Development Process;
database means for storing information relative to Activities that are performed during the Drug Development Process; and
computer means for calculating a forecast of Direct Project Resources required for the Candidate during a user-selected Forecast Period, said computer means being adapted to provide for the Candidate:
(i) an expected position in the Drug Development Process,
(ii) an Attrition Adjustment Factor,
(ii) Activities in the user-selected Forecast Period that are at least partially completed, and
(iii) the Direct Project Resources required for the Activities in the Forecast Period, modified by the Characteristics of the Candidate and the Attrition Adjustment Factor.

16. The system of claim 15, wherein the information relative to the Activities includes: when the Activities occur, Direct Project Resources that are needed for the Activities, and how the Direct Project Resources are modified by the Characteristics of the Candidate.

17. The system of claim 15, wherein the Characteristics of the Candidate are selected from the group consisting of: name, project code, indication, dosage form, product type, Therapeutic Area, Enhancement Status, current position in Drug Development Process, owning Site, Paradigm Data, Attrition status, and combinations thereof.

18. The system of claim 15, wherein the computer means further comprises means for calculating Direct Project Resources for each Forecast Period, for each Active Candidate for each Site, for each Cost Center, for each Activity, and for each expense type.

19. The system of claim 15, wherein the Direct Project Resources are selected from the group consisting of: personnel, materials, time, and combinations thereof.

20. The system of claim 15, wherein the computer means provides Direct Project Resources by an expected value estimation.

21. The method of claim 15, wherein the computer means provides Direct Project Resources by a simulation.

22. The method of claim 21, wherein the simulation is a Monte Carlo simulation.

23. The system of claim 15, wherein the computer means is adapted to further modify the Direct Project Resources by a Cost Driver.

24. The system of claim 15, wherein the computer means is adapted to further modify the Direct Project Resources by Candidate-specific Adjustment Factors.

25. The system of claim 15, wherein the computer means is adapted to further modify the Direct Project Resources by Overall Adjustment Factors.

26. The system of claim 15, wherein a user accesses the database means and computer means via a remote network connection.
